(19) United States
(12) Patent Application Publication
(10) Pub. No.: US 2026/0030017 A1
(43) Pub. Date: Jan. 29, 2026

(54) MACHINE LEARNING DRIVEN DEVICE FOR OPTIMIZING MEMORY SUB-SYSTEMS

(71) Applicant: Micron Technology, Inc., Boise, ID (US)

(72) Inventors: Sundararajan Sankaranarayanan, Fremont, CA (US); Aswin Thiruvengadam, Folsom, CA (US); Karthik Gulur Shivaram, Danville, CA (US); Ahmet Kaya, Davis, CA (US)

(21) Appl. No.: 19/274,963

(22) Filed: Jul. 21, 2025

Related U.S. Application Data
(60) Provisional application No. 63/675,037, filed on Jul. 24, 2024.

(51) Int. Cl. G06F 8/654; G06F 3/06

(52) U.S. Cl. CPC G06F 8/654; G06F 3/061; G06F 3/0629; G06F 3/0673

(57) ABSTRACT

A system including a plurality of memory sub-systems and an optimization device coupled to the plurality of memory sub-systems. At least one live customer-specific workload is received by the optimization device. A subset of the plurality of memory sub-systems is caused to run the at least one live customer-specific workload. Optimized parameter values associated with the subset of the plurality of memory sub-systems for the at least one live customer-specific workload is obtained. A firmware image for the subset of the plurality of memory sub-systems is generated based on the optimized parameter values.

### RELATED APPLICATIONS

This application claims the benefit of U.S. Provisional Paten Application No. 63/675,037, filed Jul. 24, 2024, which is incorporated by reference herein.

### TECHNICAL FIELD

Embodiments of the disclosure relate generally to memory sub-systems, and more specifically, relate to a machine learning driven device for optimizing memory sub-systems.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a memory sub-system optimization device that includes an optimization component in accordance with some embodiments of the present disclosure.

FIG. 2 illustrates an example computing system that includes a memory sub-system in accordance with some embodiments of the present disclosure.

FIG. 3 illustrates the optimization component of FIG. 1 in accordance with some embodiments of the present disclosure.

FIG. 4A illustrates an optimization criterion to parameter set data structure in accordance with some embodiments of the present disclosure.

FIG. 4B illustrates a target performance metric values data structure in accordance with some embodiments of the present disclosure.

FIG. 5 illustrates a score card in accordance with some embodiments of the present disclosure.

FIG. 6 is a flow diagram of an example method for optimizing memory sub-systems using an optimization device in accordance with some embodiments of the present disclosure.

FIG. 7 is a flow diagram of an example method for optimizing memory sub-systems using an optimization device in accordance with some embodiments of the present disclosure.

FIG. 8 is a block diagram of an example computer system in which embodiments of the present disclosure may operate.

### DETAILED DESCRIPTION

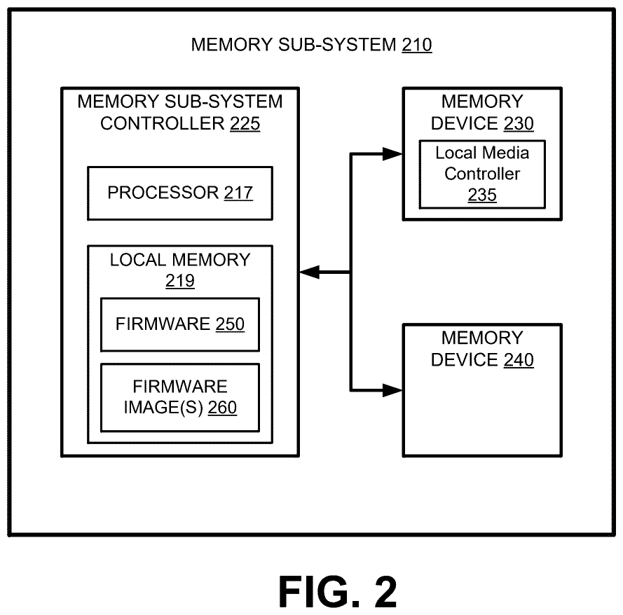

Aspects of the present disclosure are directed to an optimization device for optimizing memory sub-systems. A memory sub-system can be a storage device, a memory module, or a combination of a storage device and memory module. Examples of storage devices and memory modules are described below in conjunction with FIG. 2. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 2. A non-volatile memory device is a package of one or more dies. Each die can include of one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

One example of a memory sub-system is a solid-state drive (SSD) that includes one or more non-volatile memory devices and a memory sub-system controller to manage the non-volatile memory devices. Memory cells can be formed onto a silicon wafer in an array of columns connected by conductive lines (also hereinafter referred to as bitlines, or BLs) and rows connected by conductive lines (also hereinafter referred to as wordlines or WLs). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

Prior to and/or during manufacturing of the memory sub-systems, a default firmware is developed to be flashed onto the memory sub-system. Typically, the default firmware includes a preconfigured set of parameter values that are used to define and manage a plurality of parameters of the memory sub-system that causes the memory sub-system when processing the wide range of workloads to produce a set of performance metrics. Each performance metric of the performance metrics satisfies a default metric value associated with a respective performance metric. In other words, the performance metrics satisfy a default performance metric values. The plurality of parameters of the memory sub-system can include, for example, firmware timers, a number of suspend operations, a number of commands to process in a suspend state, read priorities, write priorities, discard priorities, etc. Typically, the plurality of parameters is concealed from view or direct modification by an entity (e.g., a customer) other than the manufacturer. The preconfigured set of parameter values when applied to the plurality of parameters of the memory sub-system satisfy a default performance metric values. The default performance metric values include a metric value for each performance metrics of the performance metrics dictated by a manufacturer of the memory sub-system, industry standards, and/or market expectation. The performance metrics can include, for example, a read operation latency metric, a write operation latency metric, a read operation bandwidth metric, a write operation bandwidth metric, etc.

Workload refers to a sequence of one or more memory access operations, such as read operations, write operations, and/or erase operations which are generated from applications (or software programs/systems) to be processed by the memory sub-system. Workloads can be characterized by factors such as input/output operations per second (IOPS), sequential read/write patterns, random read/write patterns, ratio of read to write operations, overall data throughput, etc. As noted above, the default firmware is developed to cause the memory sub-system when processing a wide range of workloads to produce performance metrics that satisfy default performance metric values. Some customers (or third-party vendors) may need to be able to process workloads from a customer (e.g., a customer-specific workloads) and/or meet target performance metric values for the set of performance metrics. Similar to the default performance metric values, the target performance metric values include a performance metric value for each performance metrics of the performance metrics dictated by the customer. As such, customized parameter values that are optimized based on the memory sub-system processing the customer-specific workloads which satisfies target performance metric values is required.

In order to generate the customized parameter values to be included in a firmware (e.g., a custom firmware) to be flashed on to the memory sub-system, the manufacturer of the memory sub-system must receive the customer-specific workloads and/or the target performance metric values for the performance metrics prior to and/or during manufacturing of the memory sub-systems. Receiving the customer-specific workloads and/or target performance metrics prior to and/or during manufacturing of the memory sub-systems, allows the manufacturer to optimize a set of parameter values that are used to define and manage plurality of parameters of the memory sub-system that causes the memory sub-system when processing the customer-specific workloads to produce performance metrics that satisfy the target performance metric values for the set of performance metrics. However, customers are typically unwilling to provide details of customer-specific workloads due to issues related to privacy, security, competitive advantage, and intellectual property.

Rather than providing details of customer-specific workloads to acquire a memory sub-system equipped with custom firmware, customers (or third-party vendors) provide the manufacturer with a generalization of the customer-specific workloads. The generalization typically outlines fundamental requirements such as IOPS needs, read/write ratios, or storage capacity demands, without disclosing detailed underlying data or business processes. A memory sub-system with the custom firmware, tailored based on the generalization of these customer-specific workloads, can achieve greater optimization for the customer-specific workloads compared to a memory sub-system with default firmware. Thus, there is a need to facilitate the utilization of the customer-specific workloads, not a generalization of the customer-specific workloads, to acquire a memory sub-system equipped with custom firmware while avoiding issues related to privacy, security, competitive advantage, and intellectual property.

Aspects of the present disclosure address the above and other deficiencies by having a memory sub-system optimization device (e.g., optimization device) that can be provided to a customer to generate a custom firmware based on customer-specific workloads to memory sub-systems. In some embodiments, the optimization device includes a memory sub-system optimization component (“optimization component”), which is a software and/or hardware component that generates the custom firmware based on customer-specific workloads to memory sub-systems. In some embodiments, the optimization device may include multiple peripheral device slots to facilitate insertion (e.g., plugging in) of each multiple memory sub-system of the multiple memory sub-systems into the optimization device. In some embodiments, the multiple memory sub-systems may be external to the optimization device and communication ports may be provided to facilitate connection of the multiple memory sub-systems to the optimization device. The optimization component of the optimization device receives one or more customer-specific workloads, an optimization criteria of a plurality of optimization criteria, and a set of target metric values.

Each of the multiple memory sub-systems is a memory sub-system in which the customer intends to run the one or more customer-specific workloads (or similar customer-specific workloads). In some embodiments, each of the multiple memory sub-systems corresponds to a type of memory sub-system in which the customer intends to run the one or more customer-specific workloads (or similar customer-specific workloads). The plurality of optimization criteria can include, for example, a performance optimization criteria, a quality of service (QoS) optimization criteria, a power optimization criteria, or any suitable combination thereof. Each optimization criteria of the plurality of optimization criteria corresponds to a subset of the plurality of parameters of the memory sub-system. In particular, the subset of the plurality of parameters identifies parameters of the memory sub-system associated with the optimization criteria (e.g., performance optimization criteria) that when modified affect an aspect (e.g., performance) of the memory sub-system associated with the optimization criteria.

The optimization component runs the one or more customer-specific workloads on the multiple memory sub-systems for a predetermined amount of time (e.g., minutes, hours, days, weeks, months, etc.) or until a convergence criteria is met. Convergence criteria may refer to a predetermined threshold, such as within a percentage of a target metric. The predetermined amount of time may be defined by the manufacturer of the multiple memory sub-systems or the customer. In some embodiments, the one or more customer-specific workloads may receive the one or more customer-specific workloads one by one, thus the optimization component run each customer-specific workload as it is received on a memory sub-system of the multiple memory sub-systems, a subset of the multiple memory sub-systems, or all of the multiple memory sub-systems. In some embodiments, the one or more customer-specific workloads may receive the one or more customer-specific workloads all at once, thus the optimization component runs, in parallel, the one or more customer-specific workloads on a subset of the multiple memory sub-systems. Each memory sub-system of the multiple memory sub-systems that ran a customer-specific workload of the one or more customer-specific workloads provides a measured performance metric value for each performance metric of the plurality of performance metrics based on the customer-specific workload.

The optimization component performs optimization on the subset of the plurality of parameters. Each target metric value of the target performance metric values corresponds to a metric value for a performance metric of the plurality of performance metrics. Thus, the optimization component performs optimization on the subset of the plurality of parameters by utilizing a set of algorithms (e.g., mathematical algorithms and/or machine learning optimization algorithms) that are run in sequence or separately to achieve optimization across incoming one or more customer-specific workloads, given the target performance metric values of the plurality of parameter metrics and the measured performance metric values of the plurality of parameter metrics. The set of algorithms may include, but are not limited to, sequential, heuristic, and metaheuristic approaches such as Bayesian optimization, genetic algorithms, surrogate models, etc. In general, the set of algorithms draws a set of parameter values and measures performance and/or latency metrics. In some embodiments, multiple sets are run, and observations are collected. Based on the observations, a next set(s) of parameter values are obtained. The set of algorithms monitor statistical quality of the set. For example, during optimization ran in sequence, an algorithm may identify a narrow range of parameter values for each parameter, and a subsequent algorithm may refine the narrow range of the parameter values for each parameter to a single parameter value (e.g., optimized parameter value) for each parameter of the subset of the plurality of parameters. In some implementations, the optimization component may provide the target performance metric values of the plurality of parameter metrics and the measured performance metric values of the plurality of parameter metrics to a cloud computing resource to perform optimization. The cloud computing resource, once the optimization operations are complete, returns a single parameter value (e.g., optimized parameter value) for each parameter of the subset of the plurality of parameters.

The optimization component generates a custom firmware image with the optimized parameter values for the subset of the plurality of parameters. In particular, the optimization component may include firmware code predeveloped (e.g., default firmware code) by the manufacturer of the multiple memory sub-systems in programming languages, such as, C or assembly. The default firmware code includes a plurality of parameters set with a default parameter value. In some embodiments, the default firmware code is copied, and the default parameter values of each parameter of the plurality of parameters that corresponds to a parameter of the subset of the plurality of parameters is replaced with a respective optimized parameter value. In other words, the default firmware code is updated with the optimizes parameter values to generate a custom firmware code. In some embodiments, the optimization component may finalize (e.g., ensure the firmware code is tested and ready for deployment) and validate (e.g., ensure the firmware code meets all specifications and performs reliably) the custom firmware code.

The optimization component compiles the custom firmware code into a custom firmware image. For example, the optimization component transforms the human-readable source code (e.g., custom firmware code) into a machine-readable binary format (e.g., custom firmware image) that can be loaded onto a memory sub-system. The custom firmware image may include a header, metadata, or checksums for verification. The optimization component may encrypt and/or digitally sign the custom firmware image. The custom firmware image may be encrypted using one or more encryption methods such as, for example, a cryptographic algorithm (e.g., AES—Advanced Encryption Standard). Accordingly, thus the encrypted custom firmware image is unreadable without a decryption key corresponding to the encryption key used during the encryption method. The custom firmware image may be digitally signed using a hash method, such as, for example, a cryptographic hash function (e.g., SHA-256). Thus, a digital signature created by encrypting, with a private key, a hash produced by the hash method and attached to the custom firmware that must be verified by decrypting the hash with the public key and comparing it to a freshly computed hash of the custom firmware. In some embodiments, the optimization component may include additional security features to safeguard against unauthorized access, data breaches, and other cybersecurity threats.

The optimization component may generate and output a score card, which can be used by the user to determine how well the measured performance metrics met target performance metrics after optimization. The score card can include multiple entries. Each entry of the score card is identified by an identifier (e.g., a name) of a respective performance metric of a plurality of performance metrics. Each entry includes a measured performance metric value of the respective performance metric, a target metric value of respective performance metric, and a score.

The score indicates a proximity of the measured performance metric value of the respective parameter metric to the target metric value of the respective parameter metric. In one example, the score may be a percentage indicating that the measured performance metric value of the respective parameter metric is within a zero, positive, or negative percentage from the target metric value of the respective parameter metric. In another example, the score may be a value indicating a difference, zero, positive, or negative, between the measured performance metric value of the respective parameter metric and the target metric value of the respective parameter metric. Positive indicating that the measured performance metric value of the respective parameter metric does not exceed the target metric value of the respective parameter metric. Negative indicating that the measured performance metric value of the respective parameter metric exceed the target metric value of the respective parameter metric. Zero indicating that the measured performance metric value of the respective parameter metric matches the target metric value of the respective parameter metric.

Depending on the embodiment, the optimization component may aggregate the scores of the multiple entries to generate an overall score. Aggregating the scores of the multiple entries may include, for example, averaging of the scores of the multiple entries, weighted averaging of the scores of the multiple entries, or any suitable mathematical method. The optimization component may include the overall score in the score card.

In some embodiments, the optimization component may load, into the multiple memory sub-systems, the custom firmware image. In some embodiments, the optimization component may load, into a subset of the multiple memory sub-systems, the custom firmware image. Once loaded, the optimization component may flash the latest loaded firmware (e.g., the custom firmware image). In particular, if the current firmware of the memory sub-system is out-of-date (e.g., flashed with a default firmware or a previous custom firmware), as compared to the latest loaded firmware, the latest loaded firmware is flashed to the memory sub-system.

In some embodiments, rather than the optimization component automatically loading the custom firmware image into the multiple memory sub-systems, the optimization component receives approval from the customer to proceed with loading the custom firmware image into the multiple memory sub-systems. In particular, the customer may review the outputted score card to determine whether the optimization was successful in meeting the set of target metric values. Accordingly, if the customer indicates that the optimization was successful in meeting the set of target metric values, the customer provides their approval of loading the custom firmware image into the multiple memory sub-systems. Otherwise, if the customer indicates that the optimization was not successful in meeting the set of target metric values, the customer provides their disapproval (or rejection) of loading the custom firmware image into the multiple memory sub-systems.

In some embodiments, rather than the optimization component automatically loading the custom firmware image into the multiple memory sub-systems, the optimization component determines whether a firmware loading threshold value is satisfied indicating that the optimization of parameter values of the subset of the plurality of parameters was successful. If the firmware loading threshold value is satisfied, the optimization component loads the custom firmware image into the multiple memory sub-systems, otherwise the optimization component does not load the custom firmware image into the multiple memory sub-systems. The firmware loading threshold value firmware loading threshold value is satisfied if the overall score meets or exceeds the firmware loading threshold value indicating that the optimization was successful in meeting the set of target metric values. The firmware loading threshold value firmware loading threshold value is not satisfied if the overall score does not exceed the firmware loading threshold value indicating that the optimization was not successful in meeting the set of target metric values.

Depending on the embodiment, the optimization component, in addition to loading the custom firmware image into the multiple memory sub-systems, may output the custom firmware image for use by the customer in memory sub-systems other than the multiple memory sub-systems. Depending on the embodiment, the optimization component, in lieu of loading the custom firmware image into the multiple memory sub-systems, may output the custom firmware image for use by the customer in the multiple memory sub-systems at a later time, or memory sub-systems other than the multiple memory sub-systems. The option of whether the custom firmware image is directly loaded into the multiple memory sub-systems, and/or outputted for later user may be determined by the customer via an input (e.g., target delivery method) received by the optimization component.

Advantages of the present disclosure include, but are not limited to, optimizing memory sub-systems according to an optimization criteria based on customer-specific workloads confidentially and securely (e.g., protecting against privacy, security, competitive advantage, and intellectual property risks). Additionally, providing customers the ability to adaptively optimize their memory sub-systems based on changes in their customer-specific workloads over time. As well as, providing flexibility in optimizing subsets of the memory sub-system for different customer-specific workloads.

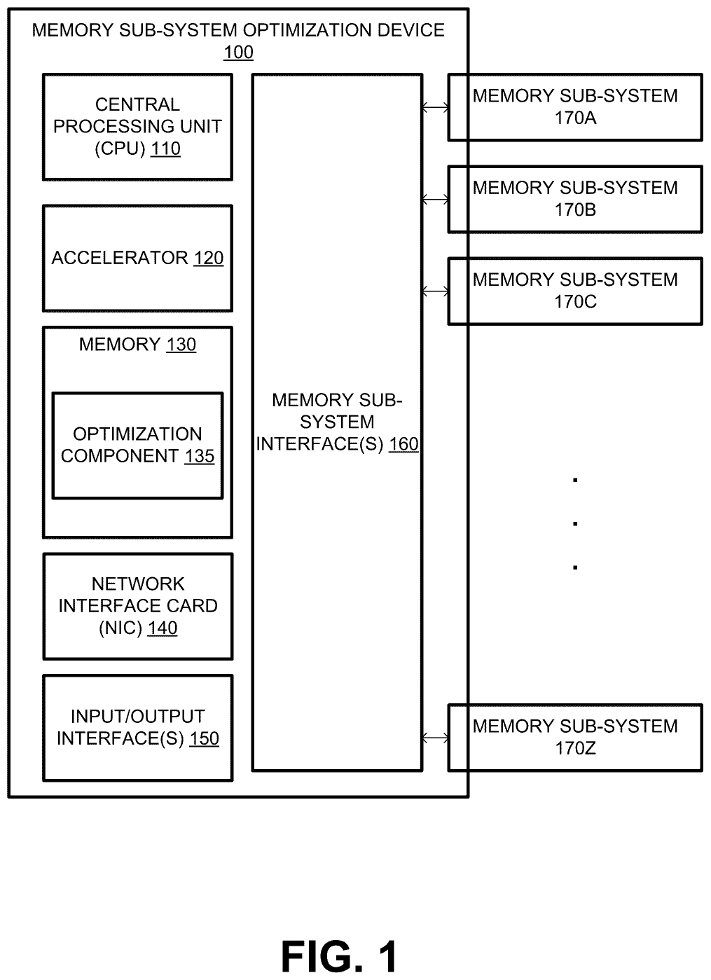

FIG. 1 illustrates a memory sub-system optimization device 100 (or optimization device 100 for simplicity) in accordance with some embodiments of the present disclosure. The optimization device 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device. The optimization device 100 can include a central processing unit (CPU) 110, an accelerator 120, a memory 130, a network interface card (NIC) 140, input/output (I/O) interface(s) 150, and memory sub-system interface(s) 160.

The CPU 110 embodies one or more processors, which may be and/or include a micro-processor, digital signal processor (DSP), or other processing component. CPU 110 may process various received data and may carry out the code or instructions or one or more computer programs, for example, to provide input/output operations specified by the instructions. The accelerator 120 may be, for example, a graphic processing unit, a tensor processing unit, a neural network processor, etc. The accelerator 120 is designed to handle specific tasks more efficiently than CPU 110. The memory 130 may include volatile memory devices (e.g., random access memory (RAM)), non-volatile memory devices (e.g., flash memory), storage devices (e.g., a magnetic hard disk, a Universal Serial Bus (USB) solid state drive, a Redundant Array of Independent Disks (RAID) system, a network attached storage (NAS) array, etc.), and/or other types of memory devices. The NIC 140 such as, for example, a network card, a network adapter, or LAN adapter enables the optimization device 100 to connect to a network. The network may be a private network (e.g., a local area network (LAN), a wide area network (WAN), intranet, etc.) or a public network (e.g., the Internet).

It should be noted that even though a single CPU 110 is depicted in FIG. 1 for optimization device 100, this is merely illustrative, and that in some other examples, optimization device 100 may include a two or more CPUs. Similarly, in some other examples, optimization device 100 may include two or more memory components, rather than a single memory component. Similarly, in some other examples, optimization device 100 may include two or more accelerators, rather than a single accelerator.

The I/O interface(s) 150 facilitates the input and output of data to and from the optimization device 100. I/O interface(s) 150 may be coupled to one or more input devices, such as, for example, keyboards, mice, scanners, and microphones which allows a user to send data to the optimization device 100. I/O interface(s) 150 may be coupled to one or more output devices, such as, for example, displays, printers, and speakers which allows data to be sent from the optimization device to a user or other systems.

The memory sub-system interface(s) 160 facilitate coupling of multiple memory sub-systems of different types (e.g., memory sub-systems 170A-Z). As previously described, each of the memory sub-systems 170A-Z is a memory sub-system, or similar to a memory sub-system, in which the customer intends to run customer-specific workloads. As used herein, “coupled to” or “coupled with” generally refers to a connection between components of the optimization device 100 and memory sub-systems 170A-Z, which can be an indirect communicative connection or direct communicative connection (e.g., without intervening components), whether wired or wireless, including connections such as electrical, optical, magnetic, etc.

Examples of memory sub-system interface(s) 160 include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The memory sub-system interface(s) 160 can be used to transmit data between the optimization device 100 and memory sub-systems 170A-Z. The optimization device 100 can further utilize an NVM Express (NVMe) interface to access components (e.g., memory devices 230) when memory sub-systems 170A-Z is coupled with the optimization device 100 by the memory sub-system interface(s) 160. The memory sub-system interface(s) 160 can provide an interface for passing control, address, data, and other signals between memory sub-systems 170A-Z and the optimization device 100. FIG. 2 illustrates a memory sub-system of memory sub-systems 170A-Z as an example. In general, the optimization device 100 can access multiple memory sub-systems via a same communication connection, multiple separate communication connections, and/or a combination of communication connections.

The optimization device 100 includes a memory sub-system optimization component 135 (optimization component 135 for simplicity) that can be provided to a customer to generate a custom firmware based on customer-specific workloads to memory sub-systems. In some embodiments, the memory 130 includes at least a portion of the optimization component 135 and is configured to perform the functionality described herein. In some embodiments, the optimization component 135 is part of the optimization device 100, an application, or an operating system.

The optimization component 135 receives, via the I/O interface(s) 150, one or more customer-specific workloads, a target optimization criteria, and a plurality of target performance metric values for a plurality of performance metrics. Each performance metric of the plurality of performance metrics is an industry-standard metric used to assess the efficiency, speed, and overall performance of the memory sub-system under a specific condition (e.g., 4 kilobyte (KB) random read, 4 KB random write, 4 KB random 70% read and 30% write, 128 KB 100% sequential reads, 128 KB 100% sequential writes, etc.). As previously described, the target optimization criteria is an optimization criteria of a plurality of optimization criteria and includes, for example, a performance optimization criteria, a quality of service (QoS) optimization criteria, a power optimization criteria, or any suitable combination thereof. Each optimization criteria of the plurality of optimization criteria corresponds to a subset of the plurality of parameters of a memory sub-system. The plurality of parameters can include firmware timers, a number of suspend operations, a number of commands to process in a suspend state, read priorities, write priorities, discard priorities, etc. In particular, the subset of the plurality of parameters identifies parameters of the memory sub-system associated with the optimization criteria (e.g., performance optimization criteria) that when modified (e.g., modification of a corresponding parameter value) affect an aspect (e.g., performance) of the memory sub-system that produce a plurality of performance metric values. Each target metric value of the plurality of target performance metric values is associated with a respective performance metric of the plurality of performance metrics and indicates an expected metric value for the respective performance metric of the plurality of performance metrics.

In some embodiments, the optimization component 135 may receive, via the I/O interface(s) 150, a selection of the memory sub-systems 170A-Z (or subset of the memory sub-systems 170A-Z) (e.g., selected memory sub-systems). If no selection of the memory sub-systems 170A-Z is received, the optimization component 135 determines that the memory sub-systems 170A-Z are selected as the selected memory sub-systems.

The optimization component 135 runs the one or more customer-specific workloads on the selected memory sub-systems in the manner they are received for a predetermined amount of time (e.g., minutes, hours, days, weeks, months, etc.) or until a convergence criteria is met. The predetermined amount of time may be predefined or received by the optimization component 135. After the optimization component 135 runs the one or more customer-specific workloads on the selected memory sub-system, each memory sub-system of the selected memory sub-systems outputs a measured performance metric value for each performance metric of the plurality of performance metrics (e.g., outputs a plurality of measured performance metric values).

In some embodiments, the optimization component 135 may receive the one or more customer-specific workloads one by one. Thus, the optimization component 135 runs each customer-specific workloads as they are received on the selected memory sub-systems. In some embodiments, the optimization component 135 may receive the one or more customer-specific workloads all at once. Thus, the optimization component 135 runs all of the one or more customer-specific workloads in parallel on the selected memory sub-systems.

The optimization component 135 receives the plurality of measured performance metric values for the plurality of performance metrics. The optimization component 135 identifies a subset of the plurality of parameters associated with the target optimization criteria. The optimization component 135 performs optimization on a subset of a plurality of parameters so that the selected memory sub-systems (or memory sub-systems similar to the selected memory sub-system) can meet the plurality of target performance metric values for the plurality of parameter metrics. The optimization component 135 performs optimization by utilizing a set of algorithms (e.g., mathematical algorithms and/or machine learning optimization algorithms) that are run in sequence or separately to achieve optimization across the one or more customer-specific workloads, given the plurality of target performance metric values and the plurality of measured performance metric values for the plurality of parameter metrics.

The set of algorithms may include, but are not limited to, bayesian optimization, genetic algorithms, surrogate models, etc. For example, during optimization ran in sequence, an algorithm may identify a narrow range of parameter values for each parameter, and a subsequent algorithm may refine the narrow range of the parameter values for each parameter to a single parameter value (e.g., optimized parameter value) for each parameter of the subset of the plurality of parameters (e.g., a plurality of optimized parameter values for the subset of the plurality of parameters).

Depending on the embodiment, the optimization component 135 may provide, via the NIC 140, the plurality of target performance metric values and the plurality of measured performance metric values for the plurality of parameter metrics to a cloud computing resource to perform optimization. Upon completion of the optimization performed by the cloud computing resource, a single parameter value (e.g., optimized parameter value) for each parameter of the subset of the plurality of parameters (e.g., the plurality of optimized parameter values for the subset of the plurality of parameters) is provided to the optimization component 135.

The optimization component 135 generates a custom firmware image with the plurality of optimized parameter values for the subset of the plurality of parameters. In particular, the optimization component 135 copies a default firmware code from memory 130. The default firmware code corresponds to firmware code predeveloped (in programming languages, such as, C or assembly) by a manufacturer of memory sub-systems 170A-Z. The default firmware code includes a plurality of default parameter values for the plurality of parameters of memory sub-systems 170A-Z. The optimization component 135 replaces, for each parameter of the subset of the plurality of parameters, a default parameter value of the plurality of default parameter values in the copy of the default firmware code that corresponds to a respective parameter of the subset of the plurality of parameters with an optimized parameter value of the plurality of optimized parameter values for the respective parameter of the subset of the plurality of parameters. Accordingly, the copy of the default firmware code includes one or more of the plurality of default parameter values updated with the plurality of optimized parameter values (e.g., a custom firmware code). The optimization component 135 may finalize (e.g., ensure the firmware code is tested and ready for deployment) and validate (e.g., ensure the firmware code meets all specifications and performs reliably) the custom firmware code.

The optimization component 135 compiles the custom firmware code into a custom firmware image. For example, the optimization component 135 transforms the human-readable source code (e.g., custom firmware code) into a machine-readable binary format (e.g., custom firmware image) that can be loaded onto a memory sub-system (e.g., selected memory sub-systems, or memory sub-systems similar to the selected memory sub-systems). The custom firmware image may include a header, metadata, or checksums for verification. The optimization component 135 may encrypt and/or digitally sign the custom firmware image. The custom firmware image may be encrypted using one or more encryption methods such as, for example, a cryptographic algorithm (e.g., AES—Advanced Encryption Standard). Accordingly, thus the encrypted custom firmware image is unreadable without a decryption key corresponding to the encryption key used during the encryption method. The custom firmware image may be digitally signed using a hash method, such as, for example, a cryptographic hash function (e.g., SHA-256). Thus, a digital signature created by encrypting, with a private key, a hash produced by the hash method and attached to the custom firmware that must be verified by decrypting the hash with the public key and comparing it to a freshly computed hash of the custom firmware.

The optimization component 135 may generate an output, via the I/O interface(s) 150, a score card. The score card includes multiple entries. Each entry of the score card is identified by a name of a respective performance metric of the plurality of performance metrics (e.g., an identifier). Each entry includes a measured performance metric value of the plurality of measured performance metric values for the respective performance metric (e.g., a respective measured performance metric value), a target metric value of plurality of target performance metric values for the respective performance metric (e.g., a respective target metric value), and a score.

The score is a value that indicates a proximity of a respective measured performance metric value to a respective target metric value. In one example, the score may be a percentage indicating that the respective measured performance metric value is within a zero, positive, or negative percentage from the respective target metric value. In another example, the score may be a value indicating a difference, zero, positive, or negative, between the respective measured performance metric value and the respective target metric value. Positive indicating that the respective measured performance metric value does not exceed the respective target metric value. Negative indicating that the respective measured performance metric value exceeds the respective target metric value. Zero indicating that the respective measured performance metric value matches the respective target metric value.

Depending on the embodiment, the optimization component 135 may aggregate the scores of the multiple entries to generate an overall score. Aggregating the scores of the multiple entries may include, for example, averaging of the scores of the multiple entries, weighted averaging of the scores of the multiple entries, or any suitable mathematical method. The optimization component 135 may include the overall score in the score card.

In some embodiments, the optimization component 135 may receive approval to proceed with loading the custom firmware image into the selected memory sub-systems or a subset of the selected memory sub-systems. In particular, a customer may review the outputted score card to determine whether the optimization was successful in meeting the set of target metric values. Accordingly, if the customer indicates that the optimization was successful in meeting the set of target metric values, the customer provides their approval of loading the custom firmware. Otherwise, if the customer indicates that the optimization was not successful in meeting the set of target metric values, the customer provides their disapproval (or rejection) of loading the custom firmware image.

In some embodiments, the optimization component 135 may automatically load, into the selected memory sub-systems or a subset of the selected memory sub-systems, the custom firmware image. In some embodiments, the optimization component 135 may load, into the selected memory sub-systems or a subset of the selected memory sub-systems, the custom firmware image based on a firmware loading threshold value. The firmware loading threshold value indicates whether the optimization was successful in meeting the set of target metric values. In particular, the optimization component 135 determines whether the firmware loading threshold value is satisfied. The firmware loading threshold value is satisfied if the overall score meets or exceeds the firmware loading threshold value indicating that the optimization was successful in meeting the set of target metric values. The firmware loading threshold value is not satisfied if the overall score does not exceed the firmware loading threshold value indicating that the optimization was not successful in meeting the set of target metric values. If the firmware loading threshold value is satisfied, the optimization component 135 loads the custom firmware image, otherwise the optimization component 135 does not load the custom firmware image.

Once loaded, the optimization component 135 may flash the latest loaded firmware (e.g., the custom firmware image). In particular, if the current firmware of a memory sub-system of the memory sub-systems 170A-Z is out-of-date (e.g., flashed with a default firmware or a previous custom firmware), as compared to the latest loaded firmware, the latest loaded firmware is flashed to the memory sub-system of the memory sub-systems 170A-Z.

Depending on the embodiment, the optimization component 135, in addition to loading the custom firmware image, may output, via the I/O interface(s) 150, the custom firmware image for use by the customer in the selected memory sub-systems, one or more of memory sub-systems 170A-Z, or any other memory sub-system similar to the memory selected memory sub-systems. Depending on the embodiment, the optimization component 135, in lieu of loading the custom firmware image, may output, via the I/O interface(s) 150, the custom firmware image for use by the customer at a later time. Accordingly, the optimization component 135 may receive a target delivery method indicating the option of directly loading the custom firmware image and/or outputting the custom firmware image for later. Further details with regards to the operations of the optimization component 135 are described below.

FIG. 2 illustrates a memory sub-system 210, similar to a memory sub-system of memory sub-systems 170A-Z of FIG. 1, in accordance with some embodiments of the present disclosure. The memory sub-system 210, for example, is used to write data from a host system to the memory sub-system 210 and read data from the memory sub-system 210 to a host system. The memory sub-system 210 can include media, such as one or more volatile memory devices (e.g., memory device 240), one or more non-volatile memory devices (e.g., memory device 230), or a combination of such.

A memory sub-system 210 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The memory devices 230, 240 can include any combination of the different types of non-volatile memory devices and/or volatile memory devices. The volatile memory devices (e.g., memory device 240) can be, but are not limited to, random access memory (RAM), such as dynamic random-access memory (DRAM) and synchronous dynamic random access memory (SDRAM).

Some examples of non-volatile memory devices (e.g., memory device 230) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 230 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 230 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 230 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 230 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 215 (or controller 215 for simplicity) can communicate with the memory devices 230 to perform operations such as reading data, writing data, or erasing data at the memory devices 230 and other such operations. The memory sub-system controller 215 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 215 can be a microcontroller, special purpose logic circuitry (e.g., a field programmable gate array (FPGA), an application specific integrated circuit (ASIC), etc.), or other suitable processor.

The memory sub-system controller 215 can include a processing device, which includes one or more processors (e.g., processor 217), configured to execute instructions stored in a local memory 219. In the illustrated example, the local memory 219 of the memory sub-system controller 215 includes an embedded memory configured to store instructions for performing various processes, operations, logic flows, and routines that control operation of the memory sub-system 210, including handling communications between the memory sub-system 210 and the host system.

In some embodiments, the local memory 219 can include memory registers storing memory pointers, fetched data, etc. The local memory 219 can also include read-only memory (ROM) for storing micro-code, firmware 250, and/or firmware image(s) 260. Firmware 250 is a set of instructions (or firmware instructions) represented as individual commands or code that dictate how the memory sub-system 210. The instructions are executed by the processor 217. Firmware image(s) 260 may be one or more firmware images. The one or more firmware images stored may be multiple versions of firmware 250 for rollback purposes, in case an update causes issues. Each firmware image of firmware image(s) 260 is a compiled, executable version of a firmware (e.g., a version of firmware 250) represented as a binary file that processor 217 can directly execute.

While the example memory sub-system 210 in FIG. 2 has been illustrated as including the memory sub-system controller 215, in another embodiment of the present disclosure, a memory sub-system 210 does not include a memory sub-system controller 215, and can instead rely upon external control (e.g., provided by an external host, or by a processor or controller separate from the memory sub-system).

In general, the memory sub-system controller 215 can receive commands or operations from the host system and can convert the commands or operations into instructions or appropriate commands to achieve the desired access to the memory devices 230. The memory sub-system controller 215 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 230. The memory sub-system controller 215 can further include host interface circuitry to communicate with the host system via the physical host interface. The host interface circuitry can convert the commands received from the host system into command instructions to access the memory devices 230 as well as convert responses associated with the memory devices 230 into information for the host system.

The memory sub-system 210 can also include additional circuitry or components that are not illustrated. In some embodiments, the memory sub-system 210 can include a cache or buffer (e.g., DRAM) and address circuitry (e.g., a row decoder and a column decoder) that can receive an address from the memory sub-system controller 215 and decode the address to access the memory devices 230.

In some embodiments, the memory devices 230 include local media controllers 235 that operate in conjunction with memory sub-system controller 215 to execute operations on one or more memory cells of the memory devices 230. An external controller (e.g., memory sub-system controller 215) can externally manage the memory device 230 (e.g., perform media management operations on the memory device 230). In some embodiments, memory sub-system 210 is a managed memory device, which is a raw memory device 230 having control logic (e.g., local media controller 235) on the die and a controller (e.g., memory sub-system controller 215) for media management within the same memory device package. An example of a managed memory device is a managed NAND (MNAND) device.

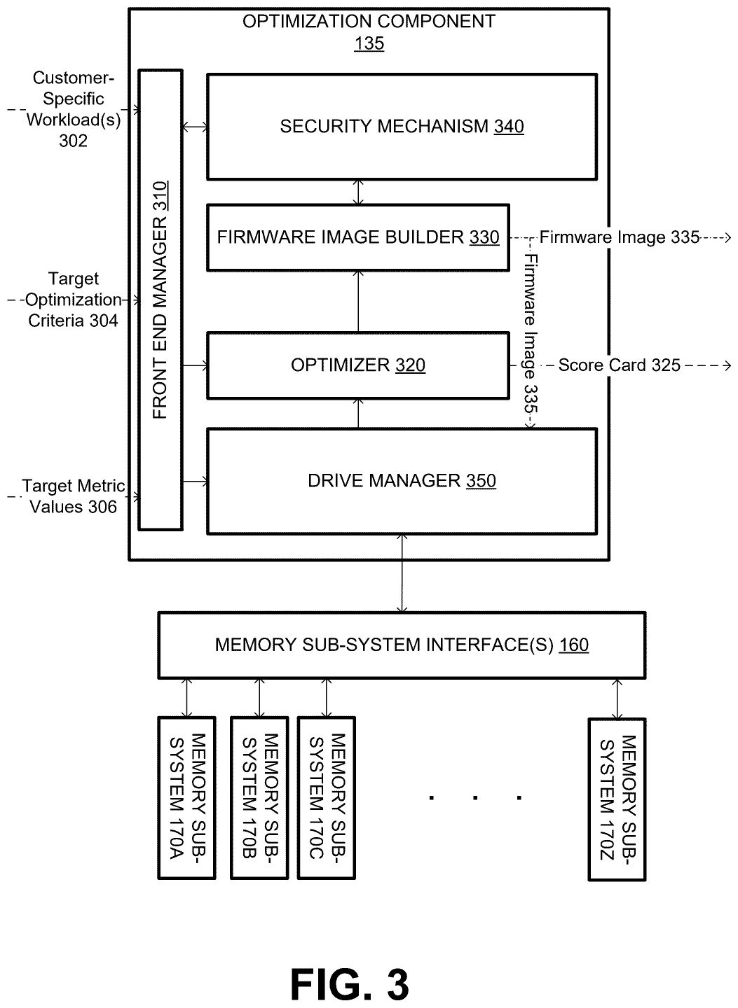

FIG. 3 illustrates an optimization component 135 of FIG. 1, in accordance with some embodiments of the present disclosure. The optimization component 135 includes a front-end manager 310, an optimizer 320, a firmware image builder 330, a security mechanism 340, and a drive manager 350.

The front-end manager 310 manages the run of workloads (e.g., starting and stopping of the workloads) and the memory sub-system running the workloads. The front-end manager 310 receives customer-specific workload(s) 302, a target optimization criteria 304, and target performance metric values 306 (e.g., a plurality of target metric values) for a plurality of performance metrics. In some embodiments, the front-end manager 310 may receive a selection of the memory sub-systems 170A-Z (or subset of the memory sub-systems 170A-Z) (e.g., selected memory sub-systems). The front-end manager 310 runs the customer-specific workload(s) 302 on the selected memory sub-systems in the manner they are received for a predetermined amount of time (e.g., minutes, hours, days, weeks, months, etc.) or until a convergence criteria is met. The predetermined amount of time may be predefined or received by the front-end manager 310. In some embodiments, the front-end manager 310 may receive the customer-specific workload(s) 302 one by one. Thus, the front-end manager 310 runs each customer-specific workloads as they are received on the selected memory sub-systems. In some embodiments, the front-end manager 310 may be receive the customer-specific workload(s) 302 all at once. Thus, the front-end manager 310 runs all of the customer-specific workload(s) 302 in parallel on the selected memory sub-systems.

The drive manager 350 is configured to manage operations of the memory sub-systems, including but not limited to, obtaining and/or recording performance metrics of the memory sub-systems and loading firmware to the memory sub-systems. In particular, each memory sub-system of the selected memory sub-systems outputs a measured performance metric value for each performance metric of the plurality of performance metrics (e.g., outputs a plurality of measured performance metric values). The drive manager 350 retrieves the plurality of measured performance metric values from each of the selected memory sub-systems. The drive manager 350 provides the plurality of measured performance metric values for each of the selected memory sub-systems to the optimizer 320.

The optimizer 320 performs optimization on parameter values associated with parameters of the memory sub-systems. In some embodiments, the optimizer 320 is located separate and apart from the optimization component 135 (e.g., in a cloud computing resource). The optimizer 320 receives the plurality of measured performance metric values for each of the selected memory sub-systems. In addition to the plurality of measured performance metric values for each of the selected memory sub-systems, the optimizer 320 receives a subset of the plurality of parameters associated with the target optimization criteria 304. In particular, the front-end manager 310 may access an optimization criteria to parameter set data structure that provides a translation of the target optimization criteria 304 to a corresponding subset of the plurality of parameters (e.g., parameter set).

The optimizer 320 performs optimization on a subset of a plurality of parameters so that the selected memory sub-systems (or memory sub-systems similar to the selected memory sub-system) can meet the target performance metric values 306 for the plurality of parameter metrics. The optimizer 320 performs optimization by utilizing a set of algorithms (e.g., mathematical algorithms and/or machine learning optimization algorithms) that are run in sequence or separately to achieve optimization across the customer-specific workload(s) 302, given the target performance metric values 306 and the plurality of measured performance metric values for the plurality of parameter metrics. The optimizer 320 outputs a single parameter value (e.g., optimized parameter value) for each parameter of the subset of the plurality of parameters (e.g., a plurality of optimized parameter values for the subset of the plurality of parameters). The optimizer 320 provides the plurality of optimized parameter values for the subset of the plurality of parameters to the firmware image builder 330.

In some embodiments, the optimizer 320 may generate and output a score card 325. The score card 325 includes multiple entries. Each entry of the score card 325 is identified by a name of a respective performance metric of the plurality of performance metrics (e.g., an identifier). Each entry includes a measured performance metric value of the plurality of measured performance metric values for the respective performance metric (e.g., a respective measured performance metric value), a target metric value of target performance metric values 306 for the respective performance metric (e.g., a respective target metric value), and a score indicating a proximity of a respective measured performance metric value to a respective target metric value. The score card 325 may include an overall score that is an aggregation of the scores of the multiple entries.

The firmware image builder 330 generates a custom firmware image with the plurality of optimized parameter values for the subset of the plurality of parameters (e.g., firmware image 335). In particular, the firmware image builder 330 copies a default firmware code from memory 130 of FIG. 1. The firmware image builder 330 replaces, for each parameter of the subset of the plurality of parameters, a default parameter value of the plurality of default parameter values in the copy of the default firmware code that corresponds to a respective parameter of the subset of the plurality of parameters with an optimized parameter value of the plurality of optimized parameter values for the respective parameter of the subset of the plurality of parameters. Accordingly, the copy of the default firmware code includes one or more of the plurality of default parameter values updated with the plurality of optimized parameter values (e.g., a custom firmware code). The firmware image builder 330 may finalize (e.g., ensure the firmware code is tested and ready for deployment) and validate (e.g., ensure the firmware code meets all specifications and performs reliably) the custom firmware code.

The firmware image builder 330 compiles the custom firmware code into a custom firmware image (e.g., firmware image 335). The firmware image builder 330 may, in conjunction with the security mechanism 340, encrypt and/or digitally sign the firmware image 335. In particular, the security mechanism 340 encrypts the custom firmware code using one or more encryption methods of the security mechanism 340. The security mechanism 340 may digitally sign the firmware image 335 using a hash method of the security mechanism 340. The firmware image builder 330 outputs the firmware image 335.

The drive manager 350 may automatically load the firmware image 335 outputted by the firmware image builder 330 into the selected memory sub-systems or a subset of the selected memory sub-systems. In some embodiments, the front-end manager 310 may receive approval or disapproval of loading the firmware image 335 into the selected memory sub-systems or a subset of the selected memory sub-systems. The front-end manager 310 provides the received approval or disapproval to the drive manager 350. The drive manager 350, based on the received approval or disapproval, loads the firmware image 335 outputted by the firmware image builder 330 into the selected memory sub-systems or a subset of the selected memory sub-systems. Once loaded, the drive manager 350 may pause the selected memory sub-systems or the subset of the selected memory sub-systems, flash firmware image 335, and resume processing the customer-specific workload(s) 302 again.

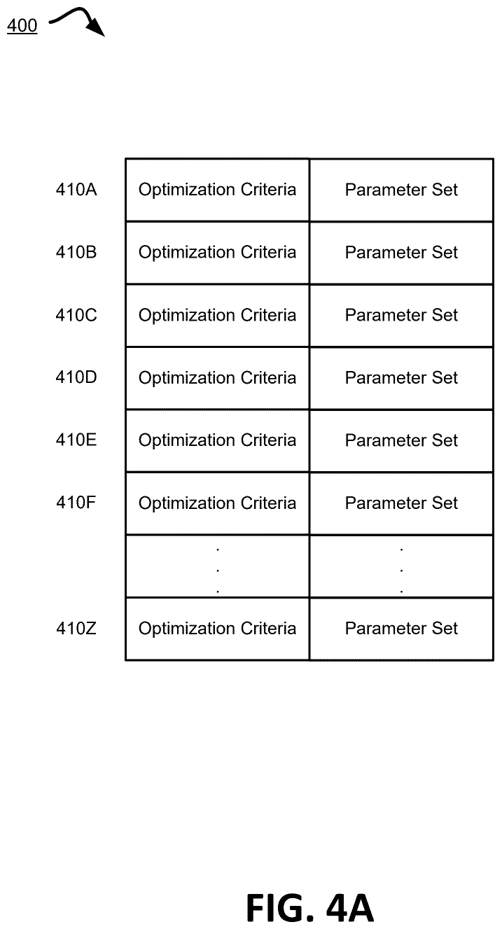

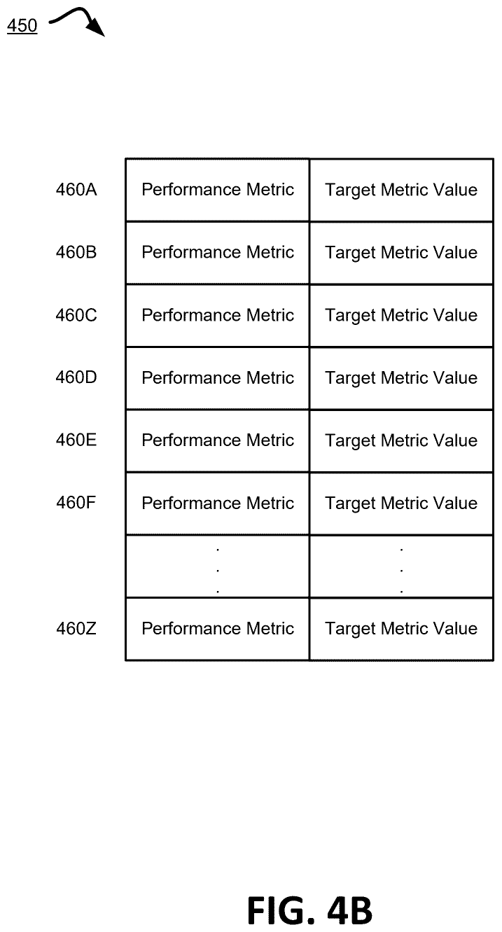

FIG. 4A illustrates an optimization criteria to parameter set data structure 400, in accordance with some embodiments of the present disclosure. The optimization criteria to parameter set data structure 400 (table 400 for simplicity). The table 400 may be stored in memory 130. The table 400 includes a plurality of entries 410A-Z. Each entry of the plurality of entries 410A-Z is identified by an optimization criteria of the plurality of optimization criteria or a combination of optimization criteria. Each entry includes a subset of the plurality of parameters represented as a parameter set that corresponds to a respective optimization criteria.

FIG. 4B illustrates a target performance metric values data structure 450, in accordance with some embodiments of the present disclosure. The plurality of target performance metric values received by the optimization device 100 of FIG. 1 and/or the front-end manager 310 of FIG. 3 may be represented as target performance metric values data structure 450. The target performance metric values data structure 450 may be stored in memory 130. The target performance metric values data structure 450 includes a plurality of entries 460A-Z. Each entry of the plurality of entries 460A-Z is identified by a name associated with a performance metric of the plurality of performance metrics. Each entry includes a target metric value for a respective performance metric.

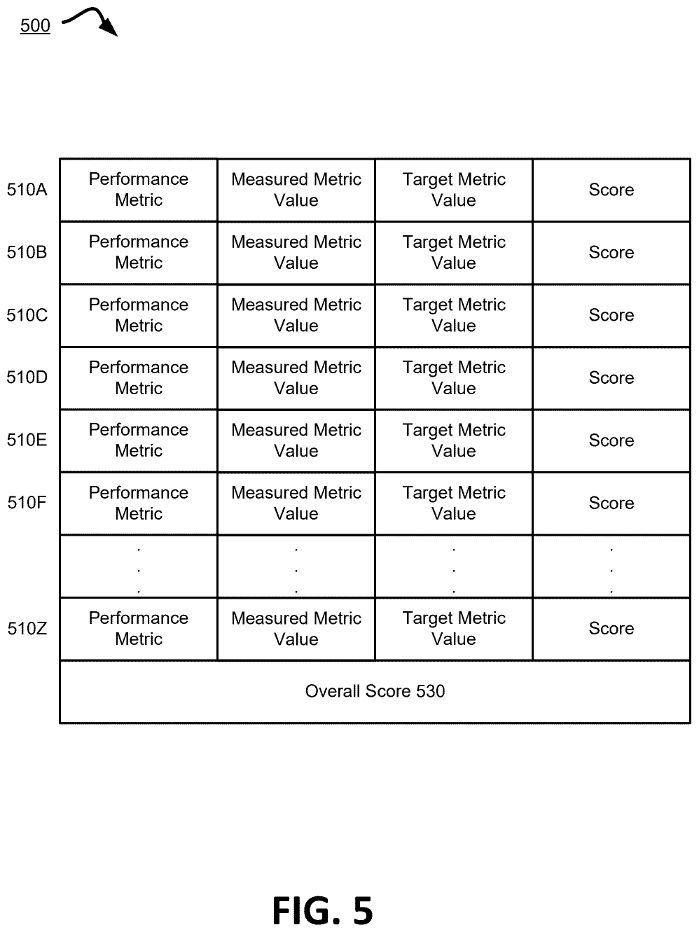

FIG. 5 illustrates the score card 500 outputted by the optimization device 100 of FIG. 1 and/or the optimizer 320 of FIG. 3, in accordance with some embodiments of the present disclosure. The score card 500 may be stored in memory 130. The score card 500 includes a plurality of entries 510A-Z. Each entry of the plurality of entries 510A-Z is identified by a name of a performance metric of the plurality of performance metrics. Each entry includes a target metric value for a respective performance metric, a measured performance metric value for the respective performance metric, and a score based on the target metric value and the measured performance metric value. In some embodiments, the score card 500 may include an overall score 530.

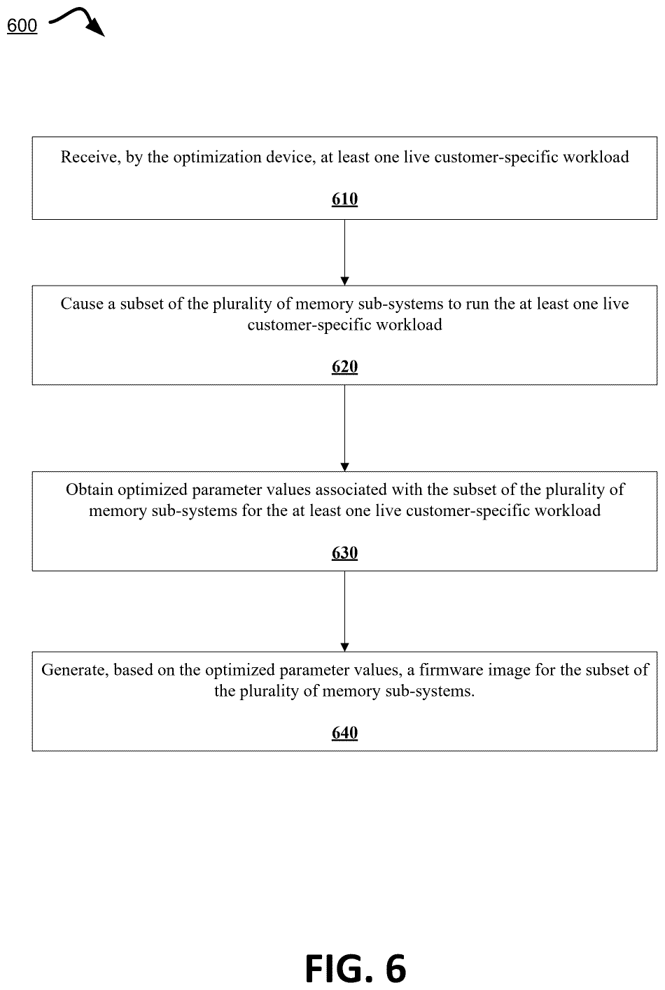

FIG. 6 is a flow diagram of an example method 600 for optimizing memory sub-systems using an optimization device, in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the optimization component 135 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 610, the processing logic receives, by the optimization device, at least one live customer-specific workload. As previously described, the at least one live customer-specific workload includes details of the underlying data or business processes and is not a generalization (e.g., outlining fundamental requirements).

At operation 620, the processing logic causes a subset of the plurality of memory sub-systems to run the at least one live customer-specific workload. In particular, the processing logic receives, by the optimization device, a selection of the subset of the plurality of memory sub-systems and causes the at least one live customer-specific workload to run on the subset of the plurality of memory sub-systems for one of: a predetermined amount of time (e.g., minutes, hours, days, weeks, months, etc.) or until a convergence criteria is met. As previously described, in some embodiments, the one or more customer-specific workloads may receive the one or more customer-specific workloads one by one, thus each customer-specific workload is ran as it is received on a subset of the plurality of memory sub-systems. In some embodiments, the one or more customer-specific workloads may receive the one or more customer-specific workloads all at once, thus the one or more customer-specific workloads runs, in parallel, on the subset of the plurality of memory sub-systems. Each memory sub-system of the subset of the plurality of memory sub-systems provides a measured performance metric value for each performance metric of the plurality of performance metrics based on the customer-specific workload.

At operation 630, the processing logic obtains optimized parameter values associated with the subset of the plurality of memory sub-systems for the at least one live customer-specific workload. The processing logic receives, from the subset of the plurality of memory sub-systems, a plurality of measured performance metrics. The processing logic receives, by the optimization device, an optimization criteria and a plurality of target performance metrics. The processing logic identifies, based on the optimization criteria, a subset of a plurality of parameters associated with the subset of the plurality of memory sub-systems. As previously described, an optimization criteria to parameter set data structure provides a translation of the optimization criteria to the subset of a plurality of parameters.

The processing logic performs, based on the plurality of measured performance metrics and the plurality of target performance metrics, optimization on a parameter value associated with each parameter of the subset of the plurality of parameters. The processing logic generates optimized parameter values associated with the subset of the plurality of memory sub-systems for the at least one live customer-specific workload. As previously described, optimization is performed utilizing a set of algorithms (e.g., mathematical algorithms and/or machine learning optimization algorithms) that are run in sequence or separately to achieve optimization across the at least one customer-specific workload, given the plurality of measured performance metrics and the plurality of target performance metrics.

The processing logic provides, to a cloud computing resource, the subset of the plurality of parameters, the plurality of measured performance metrics, and the plurality of target performance metrics to perform optimization on a parameter value associated with each parameter of the subset of the plurality of parameters. The processing logic receives, from the cloud computing resource, optimized parameter values associated with the subset of the plurality of memory sub-systems for the at least one live customer-specific workload. As previously described, depending on the embodiment, the optimization component may provide the target performance metric values of the plurality of parameter metrics and the measured performance metric values of the plurality of parameter metrics to a cloud computing resource to perform optimization. The cloud computing resource, once the optimization operations are complete, returns a single parameter value (e.g., optimized parameter value) for each parameter of the subset of the plurality of parameters.

At operation 640, the processing logic generates, based on the optimized parameter values, a firmware image for the subset of the plurality of memory sub-systems. The processing logic obtains, from memory of the optimization device, default firmware code associated with the subset of the plurality of memory sub-systems. For each optimized parameter value of the optimized parameter values, the processing logic updates, with a respective optimized parameter value, a parameter value corresponding to a parameter of the subset of the plurality of memory sub-systems associated with a respective optimized parameter value. The processing logic receives compiles the default firmware code with the optimized parameter values into the firmware image. As previously described, a firmware code predeveloped (e.g., default firmware code) by the manufacturer including default parameter values is copied. The default parameter values that corresponds to the optimized parameter values are replaced. The firmware code is compiled into the firmware image (e.g., a machine-readable binary format).

In some embodiments, the processing logic may perform on the firmware image at least one of: encrypting or digital signing. As previously described, the firmware image may be encrypted using one or more encryption methods such as, for example, a cryptographic algorithm (e.g., AES—Advanced Encryption Standard). The firmware image may be digitally signed using a hash method, such as, for example, a cryptographic hash function (e.g., SHA-256).

Depending on the embodiment, the processing logic may output the firmware image, for later use, or load the firmware image on the subset of the plurality of memory sub-systems. As previously described, the firmware image may be loaded automatically, based on a score card, or based on approval from the customer. Once loaded, the firmware image may be flashed.

Depending on the embodiment, the processing logic may generate and output, based on the optimized parameter values, a score card. Each score of the score card indicates a proximity of a measured performance metric value of a plurality of performance metric values associated with the subset of the plurality of memory sub-systems to a corresponding target performance metric value. As previously described, the score card includes multiple entries. Each entry of the score card is identified by an identifier (e.g., a name) of a respective performance metric of a plurality of performance metrics. Each entry includes, in addition the score, a measured performance metric value of the respective performance metric and a target metric value of respective performance metric. The score may be a percentage indicating that the measured performance metric value of the respective parameter metric is within a zero, positive, or negative percentage from the target metric value of the respective parameter metric. In another example, the score may be a value indicating a difference, zero, positive, or negative, between the measured performance metric value of the respective parameter metric and the target metric value of the respective parameter metric.

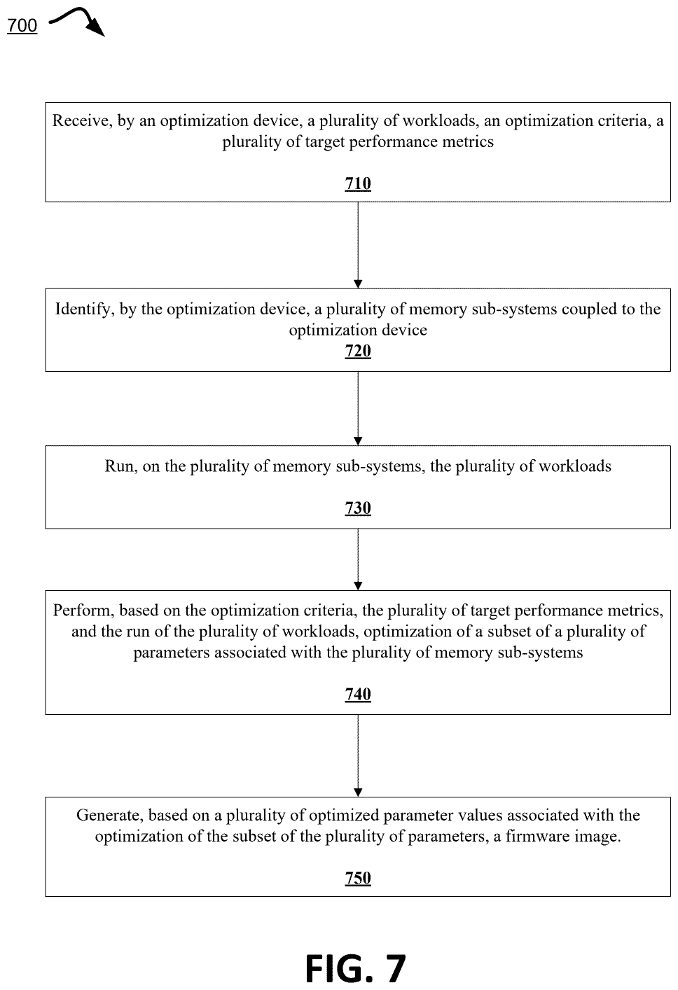

FIG. 7 is a flow diagram of an example method 700 for optimizing memory sub-systems using an optimization device, in accordance with some embodiments of the present disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by the optimization component 135 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 710, the processing logic receives a plurality of workloads, an optimization criteria, a plurality of target performance metrics. As previously described, the plurality of workloads includes details of the underlying data or business processes and is not a generalization (e.g., outlining fundamental requirements).

At operation 720, the processing logic identifies a plurality of memory sub-systems coupled to the optimization device. As previously described, the optimization device may include memory sub-system interface(s) to facilitate indirect communicative connection or direct communicative connection with memory sub-systems of different types.

At operation 730, the processing logic runs, on the plurality of memory sub-systems, the plurality of workloads. As previously described, the plurality of workloads are run on the plurality of memory sub-systems for one of: a predetermined amount of time (e.g., minutes, hours, days, weeks, months, etc.) or until a convergence criteria is met. In some embodiments, the plurality of workloads may be received one by one, thus each workload is ran as it is received on the plurality of memory sub-systems. In some embodiments, the plurality of workloads may be received all at once, thus the plurality of workloads runs, in parallel, on the plurality of memory sub-systems. Each memory sub-system of the plurality of memory sub-systems provides a measured performance metric value for each performance metric of the plurality of performance metrics based on the plurality of workloads.

At operation 740, the processing logic performs, based on the optimization criteria, the plurality of target performance metrics, and the run of the plurality of workloads, optimization of a subset of a plurality of parameters associated with the plurality of memory sub-systems. As previously described, optimization is performed utilizing a set of algorithms (e.g., mathematical algorithms and/or machine learning optimization algorithms) that are run in sequence or separately to achieve optimization across the plurality of workloads, given the plurality of target performance metrics and a plurality of measured performance metrics associated with the run of the plurality of workloads. Depending on the embodiment, the optimization component may provide the target performance metric values of the plurality of parameter metrics and the measured performance metric values of the plurality of parameter metrics to a cloud computing resource to perform optimization. The cloud computing resource, once the optimization operations are complete, returns a single parameter value (e.g., optimized parameter value) for each parameter of the subset of the plurality of parameters.

At operation 750, the processing logic generates, based on a plurality of optimized parameter values associated with the optimization of the subset of the plurality of parameters, a firmware image. As previously described, firmware code predeveloped (e.g., default firmware code) by the manufacturer including a plurality of parameters set with a default parameter value is copied. The default parameter values of each parameter of the plurality of parameters that corresponds to a parameter of the subset of the plurality of parameters are replaced with a respective optimized parameter value. The firmware code is compiled into the firmware image (e.g., a machine-readable binary format). In some embodiments, the processing logic may perform on the firmware image at least one of: encrypting or digital signing. As previously described, the firmware image may be encrypted using one or more encryption methods such as, for example, a cryptographic algorithm (e.g., AES—Advanced Encryption Standard). The firmware image may be digitally signed using a hash method, such as, for example, a cryptographic hash function (e.g., SHA-256).

Depending on the embodiment, the processing logic may output the firmware image, for later use, or load the firmware image on the subset of the plurality of memory sub-systems. As previously described, the firmware image may be loaded automatically, based on a score card, or based on approval from the customer. Once loaded, the firmware image may be flashed.

Depending on the embodiment, the processing logic may generate and output, based on the optimized parameter values, a score card. Each score of the score card indicates a proximity of a measured performance metric value of a plurality of performance metric values associated with the subset of the plurality of memory sub-systems to a corresponding target performance metric value. As previously described, the score card includes multiple entries. Each entry of the score card is identified by an identifier (e.g., a name) of a respective performance metric of a plurality of performance metrics. Each entry includes, in addition the score, a measured performance metric value of the respective performance metric and a target metric value of respective performance metric. The score may be a percentage indicating that the measured performance metric value of the respective parameter metric is within a zero, positive, or negative percentage from the target metric value of the respective parameter metric. In another example, the score may be a value indicating a difference, zero, positive, or negative, between the measured performance metric value of the respective parameter metric and the target metric value of the respective parameter metric.

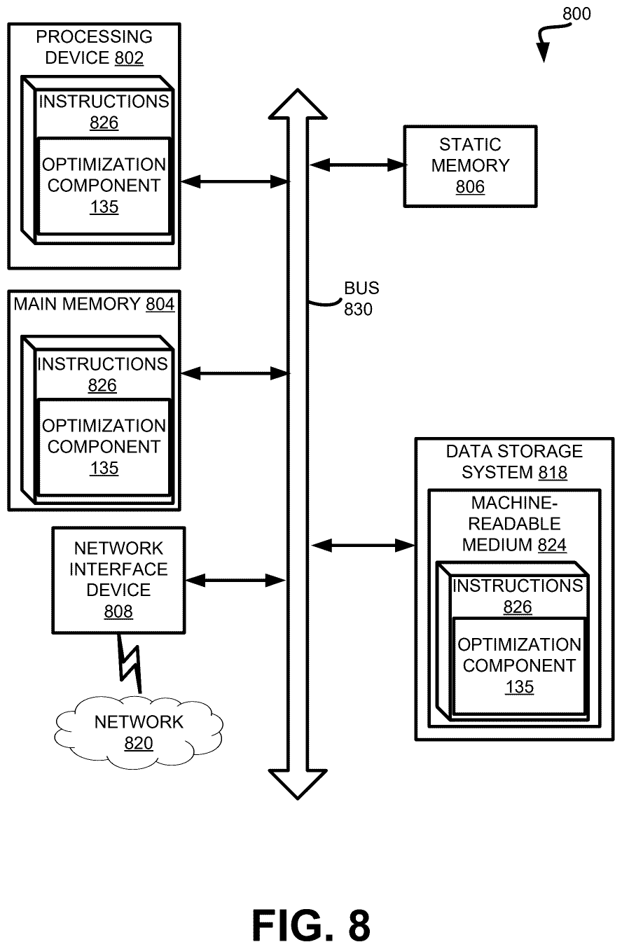

FIG. 8 illustrates an example machine of a computer system 800 within which a set of instructions, for causing the machine to perform any one or more of the methodologies discussed herein, can be executed. In some embodiments, the computer system 800 (e.g., the optimization device 100 of FIG. 1) that includes, is coupled to, or utilizes a memory sub-system (e.g., the memory sub-system 210 of FIG. 2) or can be used to perform the operations of a controller (e.g., to execute an operating system to perform operations corresponding to the optimization component 135 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or RDRAM, etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 818 can include a machine-readable storage medium 824 (also known as a computer-readable medium) on which is stored one or more sets of instructions 826 or software embodying any one or more of the methodologies or functions described herein. The instructions 826 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to the memory 130 of FIG. 1.

In one embodiment, the instructions 826 include instructions to implement functionality corresponding to an optimization component (e.g., the optimization component 135 of FIG. 1). While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory;
a processing device coupled to the memory, the processing device to perform operations comprising:
receiving at least one customer-specific workload;
causing at least a subset of a plurality of memory sub-systems to run the at least one customer-specific workload;
obtaining optimized parameter values associated with the subset of the plurality of memory sub-systems for the at least one live customer-specific workload; and
generating, based on the optimized parameter values, a firmware image for the plurality of memory sub-systems.

2. The system of claim 1, wherein the processing device is to perform operations further comprising:
performing at least one of: encrypting the firmware image or digitally signing the firmware image.

3. The system of claim 1, wherein the processing device is to perform operations further comprising:
loading the firmware image on the subset of the plurality of memory sub-systems.

4. The system of claim 1, wherein the processing device is to perform operations further comprising:
generating, based on the optimized parameter values, a score card comprising a plurality of scores, wherein each score indicates a proximity of a measured performance metric value of a plurality of performance metric values associated with the subset of the plurality of memory sub-systems to a corresponding target performance metric value; and
outputting the score card.

5. The system of claim 1, wherein causing at least one of the plurality of memory sub-systems to run at least one live customer-specific workload comprises:
receiving a selection of the subset of the plurality of memory sub-systems; and
causing the at least one live customer-specific workload to run on the subset of the plurality of memory sub-systems for one of: a predetermined amount of time or until a convergence criterion is met.

6. The system of claim 1, wherein obtaining optimized parameter values associated with the subset of the plurality of memory sub-systems for the at least one live customer-specific workload comprises:
receiving, from the subset of the plurality of memory sub-systems, a plurality of measured performance metrics;
receiving an optimization criteria and a plurality of target performance metrics;
identifying, based on the optimization criteria, a subset of a plurality of parameters associated with the subset of the plurality of memory sub-systems;
performing, based on the plurality of measured performance metrics and the plurality of target performance metrics, optimization on a parameter value associated with each parameter of the subset of the plurality of parameters; and
generating optimized parameter values associated with the subset of the plurality of memory sub-systems for the at least one live customer-specific workload.

7. The system of claim 1, wherein obtaining optimized parameter values associated with the subset of the plurality of memory sub-systems for the at least one live customer-specific workload comprises:
receiving, from the subset of the plurality of memory sub-systems, a plurality of measured performance metrics;
receiving an optimization criteria and a plurality of target performance metrics;
identifying, based on the optimization criteria, a subset of a plurality of parameters associated with the subset of the plurality of memory sub-systems; and
providing, to a cloud computing resource, the subset of the plurality of parameters, the plurality of measured performance metrics, and the plurality of target performance metrics to perform optimization on a parameter value associated with each parameter of the subset of the plurality of parameters; and
receiving, from the cloud computing resource, optimized parameter values associated with the subset of the plurality of memory sub-systems for the at least one live customer-specific workload.

8. The system of claim 1, wherein generating, based on the optimized parameter values, the firmware image comprises:
obtaining default firmware code associated with the subset of the plurality of memory sub-systems;
for each optimized parameter value of the optimized parameter values, updating, with a respective optimized parameter value, a parameter value corresponding to a parameter of the subset of the plurality of memory sub-systems associated with a respective optimized parameter value;
compiling the default firmware code with the optimized parameter values into the firmware image.

9. A method comprising:
receiving, by an optimization device, a plurality of workloads, an optimization criteria, a plurality of target performance metrics;
identifying, by the optimization device, a plurality of memory sub-systems coupled to the optimization device;
running, on the plurality of memory sub-systems, the plurality of workloads;
performing, based on the optimization criteria, the plurality of target performance metrics, and the run of the plurality of workloads, optimization of a subset of a plurality of parameters associated with the plurality of memory sub-systems;
generating, based on a plurality of optimized parameter values associated with the optimization of the subset of the plurality of parameters, a firmware image.

10. The method of claim 9, further comprising:
performing at least one of: encrypting the firmware image or digitally signing the firmware image.

11. The method of claim 9, further comprising:
loading, by the optimization device, the firmware image on the subset of the plurality of memory sub-systems.

12. The method of claim 9, further comprising:
outputting, based on the plurality of optimized parameter values, a score card comprising a plurality of scores, wherein each score is associated with a parameter of the plurality of parameters and indicates a proximity between a corresponding measured performance metric value obtained from the run of the plurality of workloads and a corresponding target performance metric value.

13. The method of claim 9, wherein the performing optimization of the subset of the plurality of parameters is performed by one of: the optimization device or a cloud computing resource communicatively coupled to the optimization device.

14. The method of claim 9, further comprising:
outputting, by the optimization device, the firmware image.

15. The method of claim 9, wherein running, on the plurality of memory sub-systems, the plurality of workloads comprises causing the plurality of workloads to run on the plurality of memory sub-systems for one of: a predetermined amount of time or until a convergence criterion is met.

16. A non-transitory computer-readable storage medium comprising instructions that, when executed by a processing device, cause the processing device to perform operations comprising:
receiving, by an optimization device, a plurality of workloads, an optimization criteria, a plurality of target performance metrics;
identifying, by the optimization device, a plurality of memory sub-systems coupled to the optimization device;
running, on the plurality of memory sub-systems, the plurality of workloads;
performing, based on the optimization criteria, the plurality of target performance metrics, and the run of the plurality of workloads, optimization of a subset of a plurality of parameters associated with the plurality of memory sub-systems;
generating, based on a plurality of optimized parameter values associated with the optimization of the subset of the plurality of parameters, a firmware image.

17. The non-transitory computer-readable storage medium of claim 16, wherein the processing device is to perform operations further comprising:
outputting, by the optimization device, the firmware image.

18. The non-transitory computer-readable storage medium of claim 16, wherein the processing device is to perform operations further comprising:
loading, by the optimization device, the firmware image on the subset of the plurality of memory sub-systems.

19. The non-transitory computer-readable storage medium of claim 16, wherein the processing device is to perform operations further comprising:
outputting, based on the plurality of optimized parameter values, a score card comprising a plurality of scores, wherein each score is associated with a parameter of the plurality of parameters and indicates a proximity between a corresponding measured performance metric value obtained from the run of the plurality of workloads and a corresponding target performance metric value.

20. The non-transitory computer-readable storage medium of claim 16, wherein the performing optimization of the subset of the plurality of parameters is performed by one of: the optimization device or a cloud computing resource communicatively coupled to the optimization device.
